(19) United States
(12) Patent Application Publication
(10) Pub. No.: US 2016/0261123 A1
(43) Pub. Date: Sep. 8, 2016

(54) CHARGING CIRCUIT FOR AN ENERGY STORAGE DEVICE AND METHOD FOR CHARGING AN ENERGY STORAGE DEVICE

(71) Applicant: ROBERT BOSCH GMBH, Stuttgart (DE)

(72) Inventor: Holger Rapp, Ditzingen (DE)

(21) Appl. No.: 15/032,074

(22) PCT Filed: Oct. 21, 2014
(86) PCT No.: PCT/EP2014/072481

§ 371 Date: Apr. 26, 2016

(30) Foreign Application Priority Data
Oct. 28, 2013 (DE) 10 2013 221 830.3

(51) Int. Cl. H02J 7/00; H02M 7/44; H02M 1/42; H02M 7/04

(52) U.S. Cl. CPC H02J 7/0013; H02J 7/0052; H02M 7/04; H02M 7/44; H02M 1/42

(57) ABSTRACT

The invention relates to a charging circuit for an energy storage device (1), having a multiplicity of energy supply branches (Z) each with a multiplicity of energy storage modules (3) for generating an AC voltage at a multiplicity of output connections (1a, 1b, 1c) of the energy storage device (1). The charging circuit has a first half-bridge circuit (9) having a multiplicity of first supply connections (8a, 8b, 8c) each coupled to one of the output connections (1a, 1b, 1c) of the energy storage device (1), a first supply node (37a; 37b; 47a; 47b) coupled to the first half-bridge circuit (9), a second supply node (37a; 37b; 47a; 47b) coupled to a reference potential rail (4) of the energy storage device (1), a converter inductor (10) connected between the first supply node (37a; 37b; 47a; 47b) and the first half-bridge circuit (9), a diode half-bridge (32) coupled between the first supply node (37a; 37b; 47a) and the second supply node (37a; 37b; 47b), and a supply circuit (35; 44, 45) designed to at least occasionally provide a charging DC voltage (U_{L}) between the first supply node (37a; 37b; 47a; 47b) and the second supply node (37a; 37b; 47a; 47b). In this case, the first half-bridge circuit (9) has a multiplicity of semiconductor switches (9c) each coupled between the first supply node (37a; 37b; 47a; 47b) and one of the multiplicity of first supply connections (8a, 8b, 8c).

### BACKGROUND OF THE INVENTION

The invention relates to a charging circuit for an energy storage device and a method for charging an energy storage device, in particular for charging a battery direct inverter with a DC voltage.

It has become apparent that electronic systems, which combine new energy storage technologies with electric drive technology, will increasingly be used in the future in stationary applications, such as, e.g., wind turbines or solar energy systems, as well as in vehicles, such as hybrid or electric vehicles.

The feed of multi-phase current into an electrical machine is usually accomplished by an inverter in the form of a pulse width modulated inverter. To this end, a DC voltage provided by a DC voltage intermediate circuit can be converted into a multi-phase AC voltage, for example a three-phase AC voltage. The DC voltage intermediate circuit is thereby supplied by a string of battery modules connected to one another in series. In order to be able to meet the demands for power and energy of a respective application, a plurality of battery modules is frequently connected in series in a traction battery.

The series connection of a plurality of battery modules inherently has the problem that the entire supply string fails if a single battery module fails. Such a breakdown of the energy supply string can lead to a breakdown of the entire system. In addition, reduced outputs occurring temporarily or permanently in an individual battery module can lead to drops in performance in the entire energy supply string.

A battery system having an integrated inverter function is described in U.S. Pat. No. 5,642,275 A1. Systems of this kind are known under the name of multilevel cascaded inverter or also battery direct inverter (BDI). Such systems comprise DC sources in a plurality of energy storage module strings which can be directly connected to an electrical machine or to an electrical network. As a result, single-phase or multi-phase supply voltages can be generated. In this case, the energy storage module strings comprise a plurality of energy storage modules connected in series, wherein each energy storage module has at least one battery cell and an associated controllable coupling unit, which allows the at least one battery cell respectively associated therewith to be bridged or said at least one battery cell respectively associated therewith to be connected into the respective energy storage module string. In this case, the coupling unit can be designed in such a way that said unit allows the at least one battery cell respectively associated therewith to also be connected with inverse polarity into the respective energy storage module string or also allows the respective energy module string to be interrupted. By suitably actuating the coupling units, e.g. with the aid of pulse width modulation, suitable phase signals for controlling the phase output voltage can also be provided; thus enabling a separate pulse width modulated inverter to be omitted. The pulse width modulated inverter required for controlling the phase output voltage is thus, in a manner of speaking, integrated into the BDI.

In contrast to conventional systems, BDIs generally have a higher degree of efficiency, a higher reliability and a significantly lower harmonic content of the output voltage thereof. The reliability is, inter alia, ensured due to the fact that defective, failed or not completely efficient battery cells can be bypassed by suitably actuating the coupling units in the energy supply strings associated with said battery cells. The phase output voltage of an energy storage module string can be varied by correspondingly actuating the coupling units and can particularly be adjusted in a stepped manner. The stepping of the output voltage results from the voltage of an individual energy storage module, wherein the maximum possible phase output voltage is determined by means of the sum of all of the energy storage modules of an energy storage module string.

The German patent publications DE 10 2010 027 857 A1 and DE 10 2010 027 861 A1 disclose, e.g., battery direct inverters comprising a plurality of battery module strings which can be directly connected to an electrical machine.

A constant DC voltage is not available at the output of BDIs because the energy storage cells are divided among different energy storage modules and the coupling devices thereof have to be actuated in a targeted manner in order to generate a voltage level. As a result of this division, a BDI is basically not available as a DC voltage source, for example to supply an on-board electrical system of an electric vehicle. The charging of the energy storage cells is thus not readily possible via a conventional DC voltage source.

There is therefore the need for a charging circuit for an energy storage device and a method for operating the same, with which energy storage cells of the energy storage device can be charged using a DC voltage and which also can be used to charge the energy storage device while the same delivers an output voltage for operating an electrical machine and/or a DC voltage on-board electrical system.

### SUMMARY OF THE INVENTION

According to a first aspect, the present invention relates to a charging circuit for an energy storage device having a multiplicity of energy supply branches each with a multiplicity of energy storage modules for generating an AC voltage at a multiplicity of output connections of the energy storage device. The charging circuit has a first half-bridge circuit having a multiplicity of first supply connections each coupled to one of the output connections of the energy storage device, a first supply node coupled to the first half-bridge circuit, a second supply node coupled to a reference potential rail of the energy storage device, a converter inductor connected between the first supply node and the first half-bridge circuit, a diode half-bridge coupled between the first supply node and the second supply node, and a supply circuit designed to at least occasionally provide a charging DC voltage between the first supply node and the second supply node. In this case, the first half-bridge circuit has a multiplicity of semiconductor switches each coupled between the first supply node and one of the multiplicity of first supply connections.

According to a further aspect, the present invention relates to an electric drive system comprising an energy storage device having a multiplicity of energy supply branches each with a multiplicity of energy storage modules for generating an AC voltage at a multiplicity of output connections of the energy storage device, a charging circuit according to the first aspect of the invention, the supply connections of which are each coupled to one of the output connections of the energy storage device and the second node of which is coupled to a reference potential rail of the energy storage device.

According to a further aspect, the present invention relates to a method for charging an energy storage device during a voltage generating operation of the energy storage device, the energy storage device having a multiplicity of energy supply branches each with a multiplicity of energy storage modules for generating an AC voltage at a multiplicity of output connections of the energy storage device. The method comprises the following steps: at least occasionally generating a direct current in a charging circuit as a function of a charging DC voltage, selectively coupling a supply node of the charging circuit to one or a plurality of the multiplicity of output connections of the energy storage device, which have a lower output potential than a reference potential rail of the energy storage device, via a half-bridge circuit, feeding the direct current into a portion of the energy storage modules via the output connections coupled to the charging circuit and feeding the direct current back via the reference potential rail of the energy storage device.

According to a further aspect, the present invention relates to a method for charging an energy storage device during a voltage generating operation of the energy storage device, the energy storage device having a multiplicity of energy storage branches each with a multiplicity of energy storage modules for generating an AC voltage at a multiplicity of output connections of the energy storage device. The method comprises the following steps: at least occasionally generating a direct current in a charging circuit as a function of a charging DC voltage, selectively coupling a first supply node of the charging circuit to one or a plurality of the multiplicity of output connections of the energy storage device, which have a lower output potential than a reference potential rail of the energy storage device, via a first half-bridge circuit, selectively coupling a second supply node of the charging circuit to one or a plurality of the multiplicity of output connections of the energy storage device, which have a higher output potential than a reference potential rail of the energy storage device, via a second half-bridge circuit, feeding the direct current into a portion of the energy storage modules via the output connections of the energy storage device coupled to the charging circuit and the first half-bridge circuit and feeding the direct current back into the charging circuit via the half-bridge circuit.

It is a concept of the present invention to couple a circuit to the outputs of an energy storage device, in particular a battery direct inverter, with which a direct current for charging energy storage cells of the energy storage device can be fed into the outputs of the energy storage device. To this end, provision is made for a half-bridge comprising semiconductor switches to be coupled in each case as a supply device to the output connections of the energy storage device, with the aid of which half-bridges a charging current of the charging circuit can be led via all of the output connections into the energy storage device and led out of the same via the reference potential rail of said energy storage device. In so doing, it is particularly advantageous if a diode half-bridge of a DC voltage tap arrangement can be used as a supply device of the charging circuit, said diode half-bridge already being present for providing a further DC voltage level, for example for supplying an intermediate circuit capacitor of the on-board electrical system from the energy storage device. In addition, a charging of the energy storage device by means of the charging circuit can also be carried out if the energy storage device is now located in the voltage generating mode, for example when generating voltage for a connected electrical machine. Said charging of the energy storage device can be ensured by virtue of the fact that only those output connections are always connected to the charging circuit by means of the semiconductor switches, which have a potential with respect to the reference potential rail of the energy storage device that has the opposite sign as the charging current flowing from these output connections to the charging circuit. It is thereby ensured that the charging current is only supplied to those energy supply branches of the energy supply device, the output voltage of which is currently polarized in such a manner that energy is supplied to said branches by means of the charging current, and that other energy supply branches, from which energy would be removed by means of the charging current due to the current polarity of the output voltage thereof, are decoupled from the charging circuit.

One of the advantages of the charging circuit is that it is compatible with a DC voltage tap arrangement. That means that the charging circuit and the DC voltage tap arrangement do not affect each other in the respective operation. A further advantage is that the number of components for the simultaneous configuration of the charging circuit and a DC voltage tap arrangement can be held to a minimum because a number of the components have a double functionality. As a result, the component requirement and therefore the installation space requirements as well as the weight of the system decrease, in particular in an electric drive system, for example in an electrically operated vehicle.

The active operation of the charging circuit can advantageously coincide with that of the DC voltage tap arrangement, and this can even occur in the active operating state of the energy storage device. The DC voltage tap arrangement can, for example, be simultaneously activated with the charging circuit in a driving mode of an electrically driven vehicle comprising an energy storage device which has a charging circuit and a DC voltage tap arrangement; thus enabling the energy storage device to be charged even during an active operating mode. This can particularly advantageously be the case in electrically driven vehicles with so-called range extenders.

By using a half-bridge comprising semiconductor switches as a supply device, it can advantageously be ensured that charging energy can be supplied to the energy storage device in any case because a charging current through the semiconductor switches can selectively be supplied to only those energy supply branches in which the present polarity of the output voltage thereof in combination with the current flow direction of the charging current brings about an energy supply to the battery modules thereof.

According to one embodiment of the charging circuit according to the invention, the first half-bridge circuit can furthermore comprise a multiplicity of diodes which are each coupled between the first supply node and one of the multiplicity of first supply connections.

According to a further embodiment of the charging circuit according to the invention, the first half-bridge circuit can furthermore have a multiplicity of commutation chokes which are each coupled between the multiplicity of diodes or semiconductor switches and the first supply node.

According to a further embodiment of the charging circuit according to the invention, the charging circuit can furthermore have a multiplicity of second supply connections, which are each coupled to one of the output connections of the energy storage device, the second half-bridge circuit being connected to the second supply node, wherein the second half-bridge circuit has a multiplicity of semiconductor switches which are each coupled between the second supply node and one of the multiplicity of second supply connections.

According to a further embodiment of the charging circuit according to the invention, the second half-bridge circuit can have a multiplicity of diodes which are each coupled between the second supply node and one of the multiplicity of second supply connections.

According to a further embodiment of the charging circuit according to the invention, the second half-bridge circuit can furthermore have a multiplicity of commutation chokes which are each coupled between the multiplicity of diodes or semiconductor switches and the second supply node.

According to a further embodiment of the charging circuit according to the invention, the charging circuit can additionally have a first reference potential switch, which is coupled between the first supply node and the reference potential rail of the energy storage device, and a second reference potential switch, which is coupled between the second supply node and the reference potential rail of the energy storage device.

According to a further embodiment of the charging circuit according to the invention, a first reference potential diode can be connected in series with the first reference potential switch; and a second reference potential diode can be connected in series with the second reference potential switch.

According to a further embodiment of the charging circuit according to the invention, a first commutation choke can be connected in series with the first reference potential switch; and a second commutation choke can be connected in series with the second reference potential switch.

According to a further embodiment of the charging circuit according to the invention, the supply circuit can have a supply capacitor, which is coupled between two input connections of the charging circuit and which is designed to provide the charging DC voltage for charging the energy storage modules.

According to a further embodiment of the charging circuit according to the invention, the supply circuit can have a transformer, the primary winding of which is coupled between two input connections of the charging circuit, and a full bridge rectifier, which is coupled to the secondary winding of the transformer and is designed to provide a pulsating charging DC voltage for charging the energy storage modules.

According to one embodiment of the method according to the invention, the method can be used for charging an energy storage device of an electrically operated vehicle comprising an electrical drive system according to the invention.

### BRIEF DESCRIPTION OF THE DRAWINGS

Further features and advantages of embodiments of the invention ensue from the following description with reference to the accompanying drawings.

In the drawings:

FIG. 1 shows a schematic depiction of a system comprising an energy storage device:

FIG. 2 shows a schematic depiction of an energy storage module of an energy storage device;

FIG. 3 shows a schematic depiction of an energy storage module of an energy storage device;

FIG. 4 shows a schematic depiction of a system comprising an energy storage device, a charging circuit and a DC voltage tap arrangement according to one embodiment of the invention;

FIG. 5 shows a schematic depiction of a system comprising an energy storage device, a charging circuit and a DC voltage tap arrangement according to a further embodiment of the present invention;

FIG. 6 shows a schematic depiction of a system comprising an energy storage device of a charging circuit and a DC voltage tap arrangement according to a further embodiment of the present invention;

FIG. 7 shows a schematic depiction of a system comprising an energy storage device, a charging circuit and a DC voltage tap arrangement according to a further embodiment of the present invention;

FIG. 8 shows a schematic depiction of a system comprising an energy storage device, a charging circuit and a DC voltage tap arrangement according to a further embodiment of the present invention;

FIG. 9 shows a schematic depiction of a system comprising an energy storage device, a charging circuit and a DC voltage tap arrangement according to a further embodiment of the present invention;

FIG. 10 shows a schematic depiction of a first method for charging an energy storage device during a voltage generating operation of the energy storage device according to a further embodiment of the present invention; and

FIG. 11 shows a schematic depiction of a second method for charging an energy storage device during a voltage generating operation of the energy storage device according to a further embodiment of the present invention.

### DETAILED DESCRIPTION

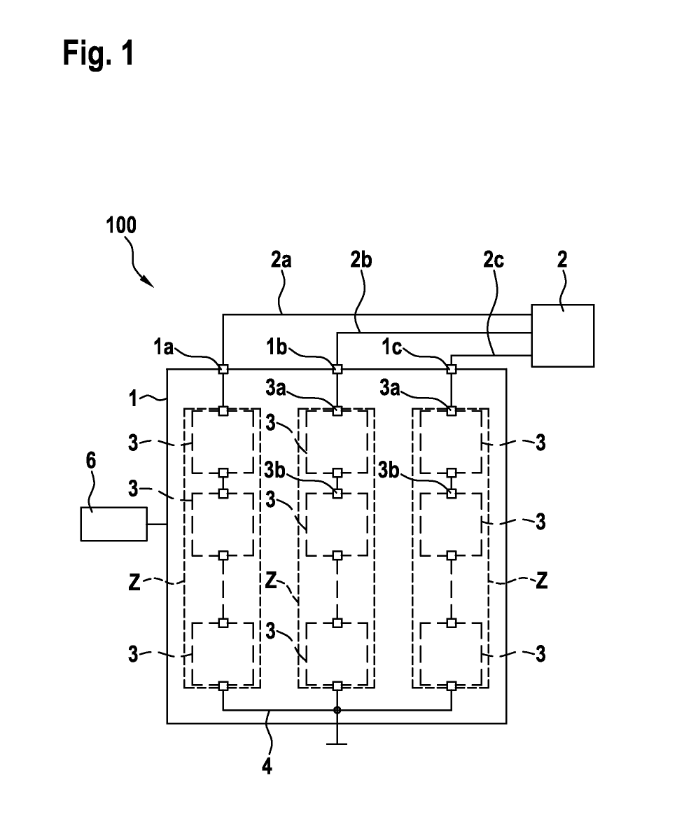

FIG. 1 shows a schematic depiction of a system 100 comprising an energy storage device 1 for the voltage conversion of DC voltage provided in energy storage modules 3 into an n-phase AC voltage. The energy storage device 1 comprises a multiplicity of energy supply branches Z, of which three are shown by way of example in FIG. 1 and which are suitable for generating a three-phase AC voltage, for example for a three-phase machine. It is, however, clear that any other number of energy supply branches Z can likewise be possible. The energy supply branches Z can have a multiplicity of energy storage modules 3, which are connected in series in the energy supply branches Z. By way of example, three energy storage modules 3 are shown in each case per energy supply branch Z, wherein any other number of energy storage modules 3 can, however, also be possible. The energy storage device 1 has an output connection 1a, 1b and 1c, the connections of which are each connected to phase lines 2a, 2b respectively 2c, available at each of the energy supply branches Z.

The system 100 can furthermore comprise a control device 6 which is connected to the energy storage device 1 and with the aid of which the energy storage device 1 can be controlled in order to provide the desired output voltages to the respective output connections 1a, 1b, 1c.

The energy storage modules 3 have each two output connections 3a and 3b, via which an output voltage of the energy storage modules can be provided. Because the energy storage modules 3 are primarily connected in series, the output voltages of the energy storage modules 3 add up to a total output voltage, which can be provided at the respective one of the output connections 1a, 1b, 1c of the energy storage device 1.

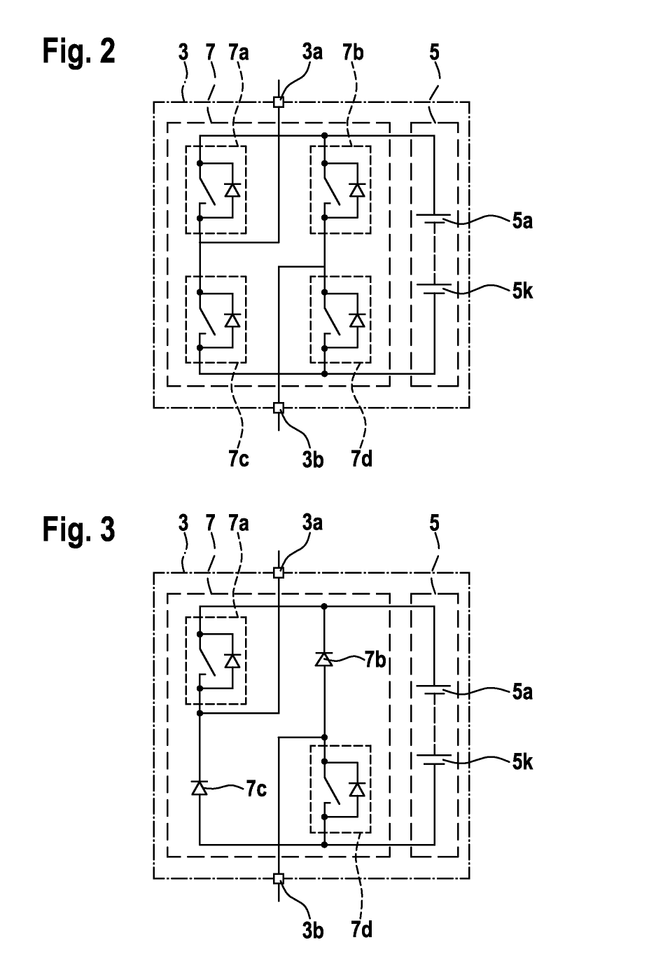

Exemplary designs of the energy storage modules 3 are shown in greater detail in FIGS. 2 and 3. The energy storage modules 3 comprise in each case a coupling device 7 having a plurality of coupling elements 7a, 7c as well as, if applicable, 7b and 7d. The energy storage modules 3 furthermore comprise respectively one energy storage cell module 5 comprising one or a plurality of energy storage cells 5a to 5k connected in series.

The energy storage cell module 5 can, by way of example, have batteries 5a to 5k, e.g. lithium-ion batteries, connected in series. In so doing, the number of energy storage cells 5a to 5k in the energy storage modules 3 shown in FIGS. 2 and 3 is two by way of example, wherein any other number of energy storage cells 5a to 5k is, however, also possible.

The energy storage cell modules 5 are connected via connection lines to input connections of the associated coupling device 7. The coupling device 7 is designed by way of example as a full bridge circuit comprising respectively two coupling elements 7a, 7c and two coupling elements 7b, 7d. The coupling elements 7a, 7b, 7c, 7d can each have an active switching element, for example a semiconductor switch, and a free-wheeling diode connected in parallel thereto. Provision can thereby be made for the coupling elements 7a, 7b, 7c, 7d to be designed as MOSFET switches, which already have an intrinsic diode, or as IGBT switches. It is alternatively possible for only two coupling elements 7a, 7d to be designed in each case to comprise an active switching element; thus enabling—as exemplarily depicted in FIG. 3—an asymmetrical half-bridge circuit to be implemented.

The coupling elements 7a, 7b, 7c, 7d can be actuated in such a way, e.g. with the aid of the control device 6 depicted in FIG. 1, that the respective energy storage cell module 5 is selectively switched between the output connections 3a and 3b or that the energy storage cell module 5 is bypassed. With reference to FIG. 2, the energy storage cell module 5 can, for example, be switched in the forward direction between the output connections 3a and 3b by the active switching element of the coupling element 7d and the active switching element of the coupling element 7a being moved into a closed state while the remaining two active switching elements of the coupling elements 7b and 7c are moved into an open state. A bypass state can, for example, be set as a result of the two active switching elements of the coupling elements 7a and 7b being moved into a closed state while the two active switching elements of the coupling elements 7c and 7d are held in the open state. A second bypass state can be set as a result of the two active switching elements of the coupling elements 7a and 7b being held in the open state while the two active switching elements of the coupling elements 7c and 7d are moved into the closed state. Finally, the energy storage cell module 5 can, for example, be switched in the reverse direction between the output connections 3a and 3b by the active switching element of the coupling element 7b and the active switching element of the coupling element 7c being moved into a closed state while the two remaining active switching elements of the coupling elements 7a and 7d are moved into an open state. Analogous considerations can be made in each case for the asymmetrical half-bridge circuit in FIG. 3. By suitably actuating the coupling devices 7, individual energy storage cell modules 5 of the energy storage modules 3 can therefore be integrated into the series circuit of an energy supply branch in a targeted manner and with any polarity.

The system 100 in FIG. 1 is used by way of example to supply electrical current to a three-phase electrical machine 2, for example in an electric drive system for an electrically operated vehicle. Provision can, however, also be made for the energy storage device 1 to be used to generate electrical current for an energy supply network 2. The energy supply branches Z can be connected to a reference potential 4 (reference potential rail) at the end thereof connected to a neutral point. The reference potential 4 can, for example, be a ground potential. The potential of the ends of the energy supply branches Z connected to a neutral point can by definition be fixed as the reference potential 4 even without further connection to a reference potential lying outside of the energy supply device 1.

Only a portion of the energy storage cell modules 5 of the energy storage modules 3 is usually required for generating a phase voltage between the output connections 1a, 1b and 1c on the one hand and the reference potential rail 4 on the other hand. The coupling devices 7 of said energy storage cell modules 5 of the energy storage modules 3 can be actuated in such a way that the total output voltage of an energy supply branch Z can be set in a stepped manner in a rectangular voltage/current adjusting range between the negative voltage of an individual energy storage cell module 5 that is multiplied by the number of the energy storage modules 3 and the positive voltage of an individual energy storage cell module 5 that is multiplied by the number of energy storage modules 3 on the one hand and between the negative and the positive nominal current through an individual energy storage module 3 on the other hand.

Such an energy storage device 1 as shown in FIG. 1 has different potentials at the output connections 1a, 1b, 1c at different points in time during operation and can therefore not readily be used as a DC voltage source. Particularly in electrical drive systems of electrically operated vehicles, it is often desirable to feed the on-board electrical system of the vehicle, for example a high voltage on-board electrical system or a low voltage on-board electrical system, from the energy storage device 1. For that reason, a DC voltage tap arrangement is provided which is designed to be connected to an energy storage device 1 and while being supplied by the same to provide a DC voltage, for example for the on-board electrical system of an electrically operated vehicle.

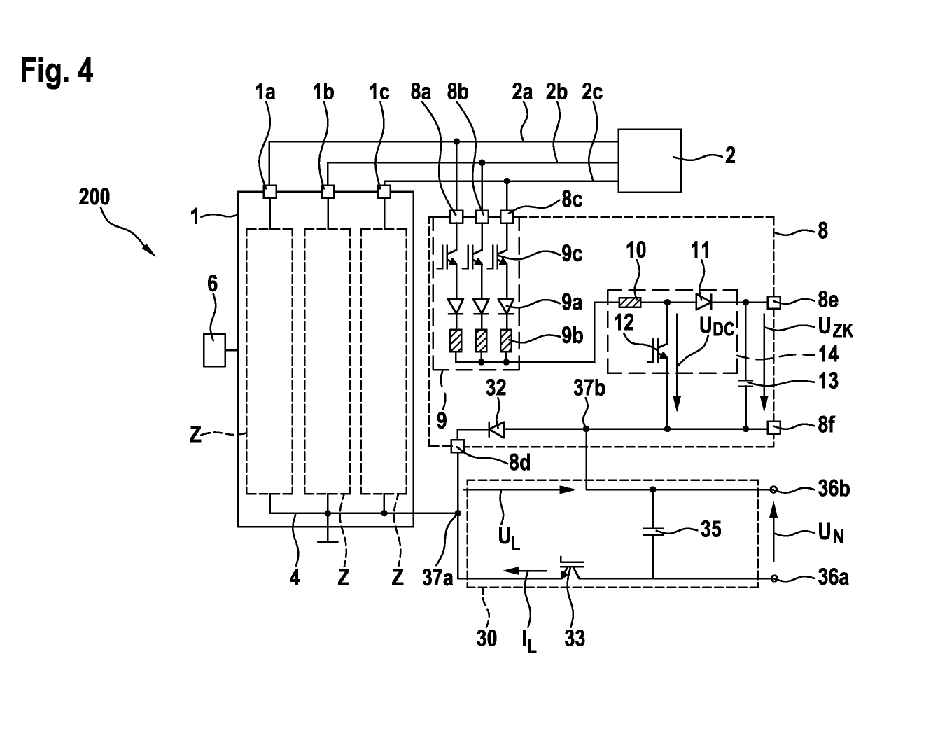

FIG. 4 shows a schematic depiction of a system 200 comprising an energy storage device 1 and such a DC voltage tap arrangement 8. The DC voltage tap arrangement 8 is on the one hand coupled to the energy storage device 1 via first collecting connections 8a, 8b, 8c and on the other hand via a reference potential connection 8d. A DC voltage U_{ZK} of the DC voltage tap arrangement 8 can be tapped at the tap connections 8e and 8f A DC-to-DC converter (not shown) for an on-board electrical system of an electrically operated vehicle can, for example, be connected to the tap connections 8e and 8f; or—in the case of a suitable balance between the voltage U_{ZK} between the tap connections 8e and 8f and the vehicle voltage—the on-board electrical system can be directly connected.

The DC voltage tap arrangement 8 has a first half-bridge circuit 9 which is coupled in each case via the first collecting connections 8a, 8b, 8c to one of the output connections 1a, 1b, 1c of the energy storage device 1. The first collecting connections 8a, 8b, 8c can, for example, be coupled to the phase lines 2a, 2b or 2c of the system 200. The first half-bridge circuit 9 can have a multiplicity of first diodes 9a which are each coupled to one of the collecting connections 8a, 8b, 8c; thus enabling anodes of the diodes 9a to be connected in each case to the phase lines 2a, 2b or 2c. The cathodes of the diodes 9a can be interconnected at a common collecting point of the first half-bridge circuit 9.

The first half-bridge circuit 9 furthermore comprises a multiplicity of first semiconductor switches 9c, which are each coupled in series with one of the multiplicity of first diodes 9a to one of the collecting connections 8a, 8b, 8c. Alternatively, the first diodes 9a can be omitted if the semiconductor switches 9c are designed as transistors with reverse blocking capability.

The first semiconductor switches 9c can selectively connect the common collecting point to selected output connections 1a, 1b, 1c or, respectively, phase lines 2a, 2b, 2c. As a result, it can be ensured that in each case the currently highest potential of the phase lines 2a, 2b or 2c that have been switched on is applied to the collecting point of the half-bridge circuit 9. In addition, a multiplicity of first commutation chokes 9b can optionally be provided, which are each coupled between the first semiconductor switches 9c and the collecting point of the first half-bridge circuit 9. The first commutation chokes 9b can buffer potential fluctuations, which can occasionally occur due to activation-induced, stepped changes in potential in the respective phase lines 2a, 2b and 2c; thus enabling the first diodes 9a and/or the first semiconductor switches 9c to be less affected by the frequent commutation processes.

The half-bridge circuit 9 is coupled in each case via the collecting point thereof to one of two input connections of a step-up converter 14. A potential difference, which can be increased by the step-up converter 14, exists between the collecting point and the reference potential rail 4 of the energy storage device 1. In this case, the step-up converter 14 is designed to provide a DC voltage U_{ZK} to the tap connections 8e, 8f of the DC voltage tap arrangement 8 as a function of the mean potential difference between the collecting point of the half-bridge circuit 9 and the reference potential rail 4 of the energy storage device 1. The step-up converter 14 can, for example, have a converter inductor 10 and an output diode 11 in a series circuit, the center tap of which couples an actuator switching element 12 to the reference potential rail 4. The converter inductor 10 can also alternatively be provided between the reference potential rail 4 and the actuator switching element 12; or two converter inductors 10 can be provided at both input connections of the step-up converter 14. The same applies to the output diode 11 which can also alternatively be provided between the tap connection 8f and the actuator switching element 12.

The actuator switching element 12 can, for example, have a power semiconductor switch, such as, for example, a MOSFET switch or an IGBT switch. An n-channel IGBT can, for example, be used for the actuator switching element 12, which in the normal state is blocking. It should however also be pointed out here that any other power semiconductor switch can also be used for the actuator switching element 12.

The DC voltage tap arrangement 8 can furthermore have an intermediate circuit capacitor 13 which is connected between the tap connections 8e, 8f of the DC voltage tap arrangement 8 and which is designed to buffer the current pulses emitted by the step-up converter 12 and thus generate a smoothed DC voltage U_{ZK} at the output of the step-up converter. A DC voltage converter of an on-board electrical system of an electrically operated vehicle can then, for example, be supplied with current via the intermediate circuit capacitor 13; or this on-board electrical system can also in certain cases be directly connected to the intermediate circuit capacitor 13.

The system 200 of FIG. 4 additionally comprises a charging circuit 30 which has input connections 36a, 36b, to which a charging DC voltage U_{N} can be supplied. The charging DC voltage U_{N} can be generated by circuit arrangements, which are not shown, for example DC voltage converters, open- or closed-loop controlled rectifiers with a power factor correction (PFC) or something similar. The charging DC voltage U_{N} can, for example, be provided by an energy supply network connected on the input side. Said charging DC voltage U_{N} can, however, also be provided by the generator of a so-called range extender particularly if a charging of the battery modules 5 is to be carried out during the driving operation of an electric vehicle. The charging circuit 30 can furthermore have an intermediate circuit capacitor 35, via which a DC voltage can be tapped and which considerably reduces the retroactive effect of pulsating currents occurring on the input side as well as on the output side of the charging circuit 30 or of switching processes in the charging circuit 30 itself on the charging DC voltage U_{N}. An output voltage U_{L} of the charging circuit 30 can be tapped at supply nodes 37a and 37b of said charging circuit 30. In this connection, the supply nodes 37a and 37b are, on the one hand, coupled to the step-up converter 14 and, on the other hand, to the reference potential rail 4 of the energy storage device 1. The charging circuit 30 is thereby used to charge the energy storage device 2 that is connected up via the supply nodes 37a, 37b. A charging direct current I_{L} can particularly be fed into one or a plurality of the energy supply branches Z and thus into the associated energy storage modules 3, as depicted in FIGS. 1 to 3, by selectively switching the semiconductor switches 9c.

The charging circuit 30 comprises a semiconductor switch 33 and a free-wheeling diode 32, which together with the converter inductor 10 implement a buck converter. It goes without saying that the arrangement of the semiconductor switch 33 in the respective current paths of the charging circuit 30 can be varied; thus enabling the semiconductor switch 33, for example, to also be disposed between the supply node 37b and the input connection 36b. The output voltage of an energy storage module 3 to be charged or alternatively the duty cycle of the buck converter implemented via the semiconductor switch can, for example, be used as the manipulated variable for the charging current I_{L} flowing through the converter inductor 10. It may also be possible to use the input voltage applied over the intermediate circuit capacitor 35 as the manipulated variable for the charging current I_{L}.

The buck converter can, for example, also be operated in an operating state with the constant duty cycle of 1; thus enabling the semiconductor switch 33 to remain permanently closed. It may also be possible in this case to dispense with the semiconductor switch 33 and the free-wheeling path comprising the free-wheeling diode 32.

The charging circuit 30 is connected to the energy storage device 1 via the supply nodes 37a and 37b. In order to charge the energy storage device 1 during the voltage generating operation, the charging voltage U_{L} has to be on average higher than the mean value of the DC voltage U_{DC} between the supply nodes 37a and 37b. If the semiconductor switches 9c are each permanently switched on, the charging current I_{L} flows in each case over the output connection 1a, 1b or 1c to which the highest potential is temporarily currently being applied. During the voltage generating operation of the energy storage device 1, i.e., for example, in the driving mode of an electrically operated vehicle, which uses the drive system 200, this highest potential is positive with respect to the potential applied to the reference potential rail 4. As a result, additional energy is removed from the respective energy supply branch Z and a charging of the energy storage device 1 as well as a controlled setting of the charging direct current I_{L} is impossible during the driving operation.

Provision is therefore made for those semiconductor switches 9c, which would connect the charging circuit 30 to an output connection 1a, 1b or 1c of positive output potential, to be blocked. Particularly only that semiconductor switch 9c which connects the charging circuit 30 to the output connection 1a, 1b or 1c with the currently lowest output potential can be closed. As a general rule, this lowest output potential is negative with respect to the reference potential of the reference potential rail 4 during the voltage generating operation of the energy storage device. As a result, the charging current I_{L} can be selectively fed into the energy storage module 3 of those energy storage branches Z of the energy storage device 1 which are right now ready for charging due to the negative output voltage thereof.

The actuation of the semiconductor switches 9c of the half-bridge circuit 9 can, for example, be carried out by the control device 6 of the energy storage device 1.

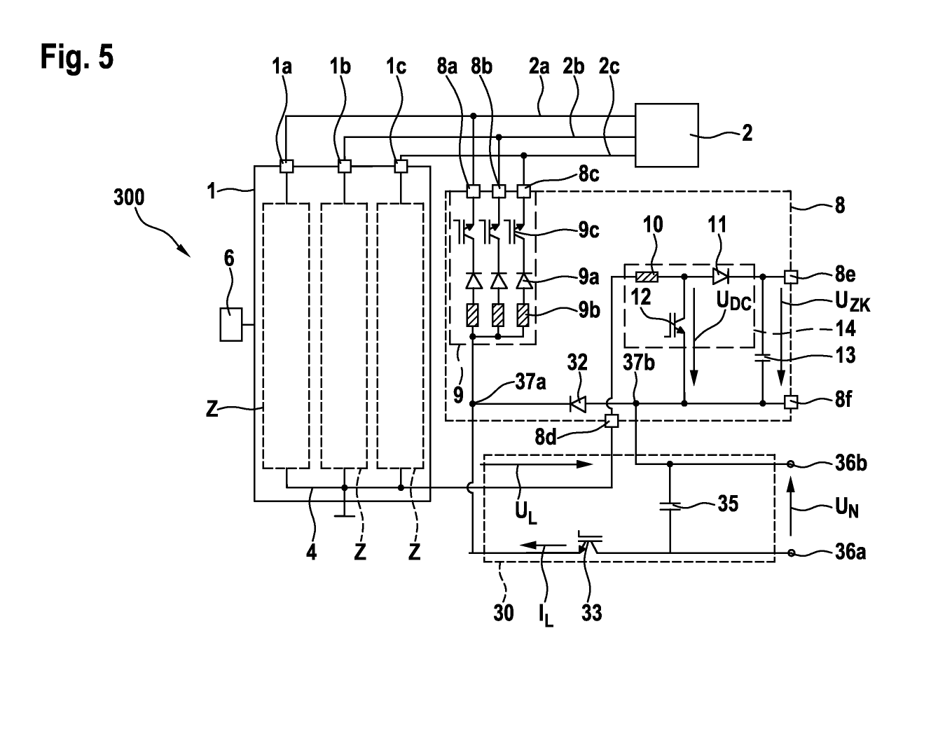

FIG. 5 shows a schematic depiction of a system 300 comprising an energy storage device 1 and a DC voltage tap arrangement 8. The system 300 differs from the system 200 shown in FIG. 4 substantially by virtue of the fact that the DC voltage tap arrangement 8 and the charging circuit 30 are connected with inverse polarity to the reference potential rail 4 or, respectively, the half-bridge circuit 9. In particular, the first supply node 37a is connected to the collecting point of the half-bridge circuit 9 and the second supply node 37b to the step-up converter 14. The converter inductor 10 is coupled to the reference potential rail 4 via the reference connection 8d.

The collecting point of the half-bridge circuit 9 is not designed as a cathode collecting point as in FIG. 4 but as an anode collecting point due to the inverse wiring of the semiconductor switches 9c and/or the diodes 9a. The same as was carried out for FIG. 4 applies to the functionality of the semiconductor switches 9c in FIG. 5.

In order to charge the energy storage device 1 during the voltage generating operation, the charging voltage U_{L} between the supply nodes 37a and 37b has to be on average higher than the mean value of the DC voltage U_{DC}. If each of the semiconductor switches 9c is permanently switched on, the charging current I_{L} flows in each case over the output connection 1a, 1b, 1c, to which the lowest potential is now temporarily applied. This lowest potential is negative with respect to the potential applied to the reference potential rail 4 in the voltage generating mode of the energy storage device 1, i.e., for example, during a driving operation of an electrically operated vehicle which uses the drive system 300. As a result, additional energy is removed from the respective energy supply branch Z, and a charging of the energy storage device 1 as well as a controlled setting of the charging direct current I_{L} is impossible during the driving operation.

Provision is therefore made to temporarily block those semiconductor switches 9c which would connect the charging circuit 30 to an output connection 1a, 1b or 1c of negative output potential. Only that semiconductor switch 9c which connects the charging circuit 30 to the output connection 1a, 1b or 1c with the currently highest output potential can be closed. As a general rule, said highest output potential is positive with respect to the reference potential of the reference potential rail 4 during the voltage generating operation of the energy storage device 1. As a result, the charging current I_{L} can selectively be fed into the energy storage modules 3 of those energy storage branches Z of the energy storage device 1 that are right now ready for charging due to the positive output voltage thereof.

The actuation of a of the semiconductor switches 9c of the half-bridge circuit 9 can, for example, be carried out by the control device 6 of the energy storage device 1.

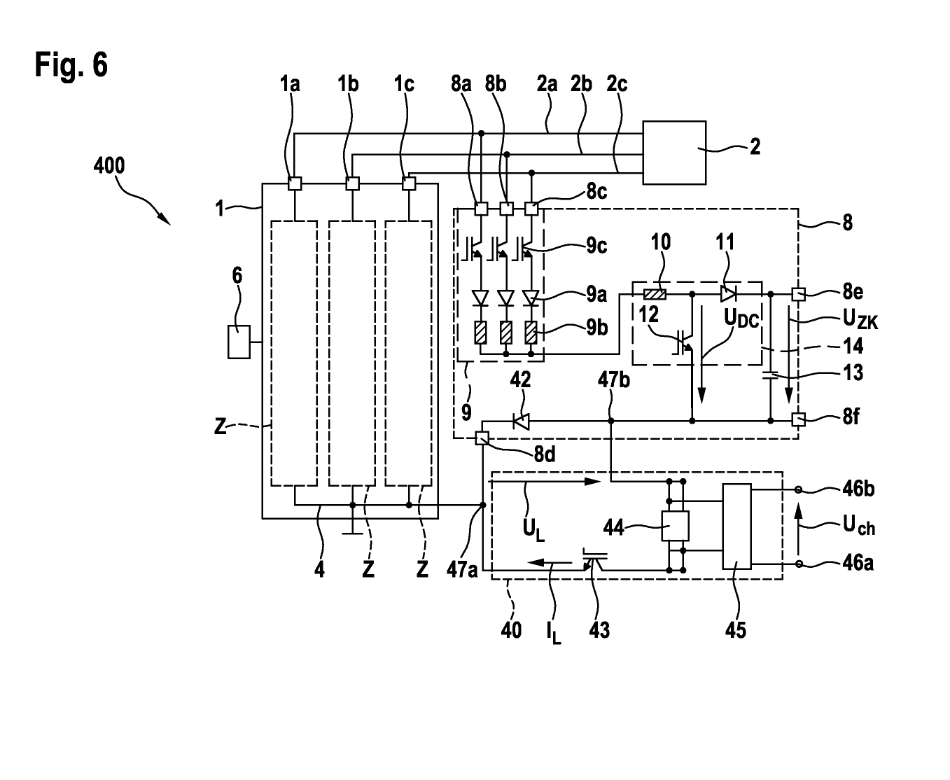

FIG. 6 shows a schematic depiction of a system 400 comprising an energy storage device 1 and such a DC voltage tap arrangement 8. The DC voltage tap arrangement 8 is, on the one hand, coupled to the energy storage device 1 via first collecting connections 8a, 8b, 8c and, on the other hand, via a reference potential connection 8d. A DC voltage U_{ZK} of the DC voltage tap arrangement 8 can be tapped at the tap connections 8e and 8f. A DC voltage converter, which is not depicted, for an on-board electrical system of an electrically operated vehicle can, for example, be connected to the tap connections 8e and 8f; or said on-board electrical system can be directly connected—in the case of a suitable balance between the voltage U_{ZK} between the tap connections 8e and 8f and the on-board electrical system voltage.

The DC voltage tap arrangement 8 comprises a first half-bridge circuit 9, which is coupled via each the first collecting connections 8a, 8b, 8c to one of the output connections 1a, 1b, 1c of the energy storage device 1. The first collecting connections 8a, 8b, 8c can, for example, be coupled to the phase lines 2a, 2b or 2c of the system 400. The first half-bridge circuit 9 can have a multiplicity of first diodes 9a, which are each coupled to one of the collecting connections 8a, 8b, 8c, so that anodes of the diodes 9a are coupled in each case to the phase lines 2a, 2b or 2c. The cathodes of the diodes 9a can be interconnected at a common collecting point of the first half-bridge circuit 9.

The first half-bridge circuit 9 further comprises a multiplicity of first semiconductor switches 9c which are each coupled in series with one of the multiplicity of first diodes 9a to one of the collecting connections 8a, 8b, 8c. The first diodes 9a can also alternatively be omitted if the semiconductor switches 9a are designed as transistors with reverse blocking capability.

The first semiconductor switches 9c can selectively connect the common collecting point to selected output connections 1a, 1b, 1c or, respectively, phase lines 2a, 2b, 2c. As a result, it can be ensured that in each case the currently highest potential of the phase lines 2a, 2b or 2c that have been switched on is applied to the collecting point of the half-bridge circuit 9. In addition, a multiplicity of first commutation chokes 9b can optionally be provided, which are each coupled between the first semiconductor switches 9c and the collecting point of the first half-bridge circuit 9. The first commutation chokes 9b can buffer potential fluctuations, which can occasionally occur in the respective phase lines 2a, 2b and 2c due to activation-induced, stepped changes in potential; thus enabling the first diodes 9a and/or the first semiconductor switches 9c to be less affected by the frequent commutation processes.

The half-bridge circuit 9 is coupled in each case via the collecting point thereof to one of two input connections of a step-up converter 14. A potential difference, which can be increased by the step-up converter 14, exists between the collecting point and the reference potential rail 4 of the energy storage device 1. In this case, the step-up converter 14 is designed to provide a DC voltage U_{ZK} to the tap connections 8e, 8f of the DC voltage tap arrangement 8 as a function of the mean potential difference between the collecting point of the half-bridge circuit 9 and the reference potential rail 4 of the energy storage device 1. The step-up converter 14 can, for example, have a converter inductor 10 and an output diode 11 in a series circuit, the center tap of which couples an actuator switching element 12 to the reference potential rail 4. The converter inductor 10 can also alternatively be provided between the reference potential rail 4 and the actuator switching element 12; or two converter inductors 10 can be provided at both input connections of the step-up converter 14. The same applies to the output diode 11 which can also alternatively be provided between the tap connection 8f and the actuator switching element 12.

The actuator switching element 12 can, for example, have a power semiconductor switch, such as, for example, a MOSFET switch or an IGBT switch. An n-channel IGBT can, for example, be used for the actuator switching element 12, which in the normal state is blocking. It should however also be pointed out here that any other power semiconductor switch can also be used for the actuator switching element 12.

The DC voltage tap arrangement 8 can furthermore have an intermediate circuit capacitor 13 which is connected between the tap connections 8e, 8f of the DC voltage tap arrangement 8 and which is designed to buffer the current pulses emitted by the step-up converter 12 and thus generate a smoothed DC voltage U_{ZK} at the output of the step-up converter. A DC voltage converter of an on-board electrical system of an electrically operated vehicle can then, for example, be supplied with current via the intermediate circuit capacitor 13; or this on-board electrical system can also in certain cases be directly connected to the intermediate circuit capacitor 13.

The system 400 of FIG. 6 further comprises a charging circuit 40, which has input connections 46a, 46b to which a charging AC voltage u_{ch} can be fed. The charging AC voltage u_{ch} can thereby be generated by circuit arrangements, which are not shown, for example inverter full bridges or something similar. Said charging AC voltage u_{ch} preferably has a rectangular, non-continuous or continuous profile and a high base frequency. Said charging AC voltage u_{ch} can, for example, be provided by means of an energy supply network, which is connected on the input side and comprises a downstream inverter or converter circuit. It can, however, also be provided by the generator of a so-called range extender likewise comprising a downstream inverter or converter circuit if a charging of the battery modules 5 is to be carried out during a driving operation of an electric vehicle. The charging circuit 40 can furthermore have a transformer 45, the primary winding of which is coupled to the input connections 46a, 46b. The secondary winding of the transformer 45 can be coupled to a full bridge rectifier circuit 44 comprising four diodes. A pulsating DC voltage can be tapped at the output of said full bridge rectifier circuit 44. A variation of the interval length of the pulsating DC voltage can take place by means of a variation of the time intervals, in which the charging AC voltage u_{ch} applied to the primary winding of the transformer 45 and therefore also the corresponding secondary voltage applied to the secondary winding of the transformer 45 have the value of 0. The charging circuit 40 is used to charge the energy storage device 1 connected up via the supply nodes 47a and 47b. Charging direct current I_{L} can particularly be fed into one or a plurality of the energy supply branches Z and therefore into the associated energy storage modules 3, as depicted in FIGS. 1 to 3, by means of the selective switching of the semiconductor switches 9c.

The charging circuit 40 has a free-wheeling diode 42, wherein the converter inductor 10 of the step-up converter 14 is used to smooth the charging direct current I_{L}. The output voltage of an energy storage arrangement to be charged, for example a series of energy storage modules 3 or a branch of the energy storage device 1, as depicted in FIGS. 1 to 3, or alternatively the steady component of the pulsating DC voltage can be used as the manipulated variable for the charging current I_{L} flowing through the converter inductor 10. In the driving mode, if the output voltages of the energy supply branches Z are predefined by the control system of the traction motor, the steady component U_{L} of the pulsating DC voltage between the output connections 47a and 47b of the charging circuit 40 can be used as the manipulated variable for the charging direct current I_{L}.

In a further embodiment, the free-wheeling diode 42 can be omitted without substitution. In this case, the diodes of the full bridge rectifier circuit 44 additionally take on the function of the freewheeling diode 42. As a result, a component is saved; however the efficiency of the charging circuit 40 is in turn reduced.

The charging circuit 40 is connected to the energy storage device 1 via the supply nodes 47a and 47b. In order to charge the energy storage device 1 during the voltage generating operation, the charging voltage U_{L} between the supply nodes 47a and 47b has to be on average higher than the mean value of the DC voltage U_{DC}. If the semiconductor switches 9c are each permanently switched on, the charging current I_{L} flows in each case over the output connection 1a, 1b, 1c, to which the highest potential is now temporarily applied. During the voltage generating operation of the energy storage device 1, i.e., for example, in the driving mode of an electrically operated vehicle which uses the drive system 400, this highest potential is positive with respect to the potential applied to the reference potential rail 4. As a result, additional energy is removed from the respective energy supply branch Z, and a charging of the energy storage device 1 as well as a controlled setting of the charging current I_{L} is impossible.

Provision is therefore made for those semiconductor switches 9c, which would connect the charging circuit 30 to an output connection 1a, 1b or 1c of positive output potential, to be temporarily blocked. Particularly only that semiconductor switch 9c which connects the charging circuit 40 to the output connection 1a, 1b or 1c with the currently lowest output potential can be closed. As a general rule, this lowest output potential is negative with respect to the reference potential of the reference potential rail 4 in the voltage generating mode of the energy storage device 1. As a result, the charging current I_{L} can be selectively fed into the energy storage modules 3 of those energy storage branches Z of the energy storage device 1 which are right now ready for charging due to the negative output voltage thereof.

The actuation of the semiconductor switches 9c of the half-bridge circuit 9 can, for example, be carried out by the control device 6 of the energy storage device 1.

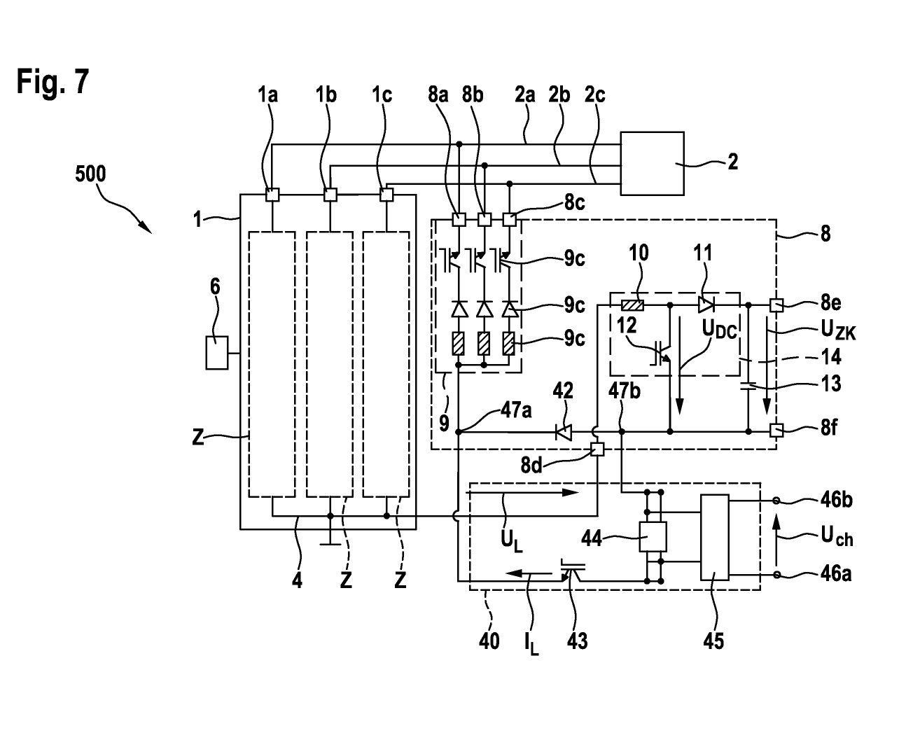

FIG. 7 shows a schematic depiction of a system 500 comprising an energy storage device 1 and a DC voltage tap arrangement 8. The system 500 differs from the system 400 shown in FIG. 6 substantially by virtue of the fact that the DC voltage tap arrangement 8 and the charging circuit 40 are connected with inverse polarity to the reference potential rail 4 or, respectively, the half-bridge circuit 9. In particular, the first supply node 47a is connected to the collecting point of the half-bridge circuit 9 and the second supply node 47b to the step-up converter 14. The converter inductor 10 is coupled to the reference potential rail 4 via the reference connection 8d.

The collecting point of the half-bridge circuit 9 is not designed as a cathode collecting point as in FIG. 6 but as an anode collecting point due to the inverse wiring of the semiconductor switches 9c and/or the diodes 9a. The same as was carried out for FIG. 6 applies to the functionality of the semiconductor switches 9c in FIG. 7.

In order to charge the energy storage device 1 during the voltage generating operation, the charging voltage U_{L} between the supply nodes 47a and 47b has to be on average higher than the mean value of the DC voltage U_{DC}. If each of the semiconductor switches 9c is permanently switched on, the charging current I_{L} flows in each case over the output connection 1a, 1b, 1c, to which the lowest potential is now temporarily applied. This lowest potential is negative with respect to the potential applied to the reference potential rail 4 in the voltage generating mode of the energy storage device 1, i.e., for example, during a driving operation of an electrically operated vehicle which uses the drive system 500. As a result, additional energy is removed from the respective energy supply branch Z, and a charging of the energy storage device 1 as well as a controlled setting of the charging direct current I_{L} is impossible during the driving operation.

Provision is therefore made for those semiconductor switches 9c, which would connect the charging circuit 30 to an output connection 1a, 1b or 1c of negative output potential, to be temporarily blocked. Particularly only that semiconductor switch 9c which connects the charging circuit 40 to the output connection 1a, 1b or 1c with the currently highest output potential can be closed. As a general rule, this highest output potential is positive with respect to the reference potential of the reference potential rail 4 during the voltage generating operation of the energy storage device. As a result, the charging current I_{L} can be selectively fed into the energy storage module 3 of those energy storage branches Z of the energy storage device 1 which are right now ready for charging due to the positive output voltage thereof.

The actuation of the semiconductor switches 9c of the half-bridge circuit 9 can, for example, be carried out by the control device 6 of the energy storage device 1.

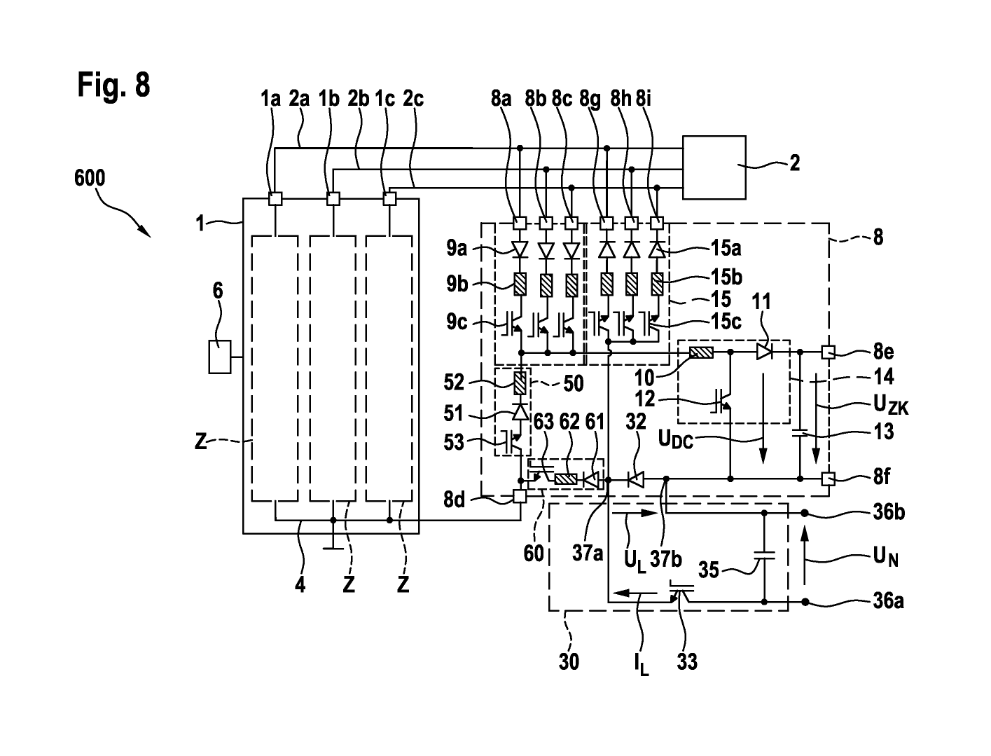

FIG. 8 shows a schematic depiction of a system 600 comprising an energy storage device 1 and a DC voltage tap arrangement 8 as well as a charging circuit 30. The system 600 differs from the system 200 shown in FIG. 4 substantially by virtue of the fact that the DC voltage tap arrangement 8 has a second half-bridge circuit 15 which is coupled via second collecting connections 8g, 8h, 8i in each case to one of the output connections 1a, 1b, 1c of the energy storage device 1. The second collecting connections 8g, 8h, 8i can, for example, be coupled to the phase lines 2a, 2b, or 2c of the system 600. The second half-bridge circuit 15 can have a multiplicity of second diodes 15a, which are each coupled to one of the second collecting connections 8g, 8h, 8i, so that cathodes of the diodes 15a are in each case coupled to the phase lines 2a, 2b or 2c. The anodes of the diodes 15a can be interconnected at a common collecting point of the second half-bridge circuit 15.

The second half-bridge circuit 15 furthermore comprises a multiplicity of second semiconductor switches 15c, which are each coupled in series with one of the multiplicity of second diodes 15a to one of the collecting connections 8a, 8b, 8c. Alternatively, the second diodes 15a can be omitted if the semiconductor switches 15c are designed as transistors with reverse blocking capability

The second semiconductor switches 15c can selectively connect the common collecting point to selected connections of the output connections 1a, 1b, 1c or, respectively, to selected lines of the phase lines 2a, 2b, 2c. As a result, it can be ensured that in each case the currently highest potential of the phase lines 2a, 2b or 2c that have been switched on is applied to the collecting point of the half-bridge circuit 1. The second commutation chokes 15b can buffer potential fluctuations, which can occasionally occur due to activation-induced, stepped changes in potential in the respective phase lines 2a, 2b or 2c; thus enabling the second diodes 15a to be less affected by the frequent commutation processes.

The first and second half-bridge circuits 9 and 15 together form a full bridge rectifier, which makes it possible to connect two of the output connections 1a, 1b, 1c or, respectively, phase lines 2a, 2b, 2c having the highest current potential difference back-to-back. By suitably selecting the blocking respectively closed semiconductor switches 9c and 15c, it can furthermore be ensured during the voltage generating operation of the energy storage device 1 that the potential difference between the output connections 1a, 1b, 1c or phase lines 2a, 2b, 2c, which are interconnected by means of the first and second half-bridge circuits 9 and 15, is opposite to the charging DC voltage U_{L} so that the charging direct current I_{L} fed into the respective energy supply branches Z supplies electrical energy to the energy storage modules 3 of said energy supply branches and does not extract electric energy from said energy storage modules.

The system 600 furthermore comprises compensation branches 50 or, respectively, 60 having semiconductor switches as reference potential switches 53 or 63, which can selectively couple the two collecting points of the first and second half-bridge circuits 9 and 15 against the reference potential rails 4 of the energy storage device 1. Reference potential diodes 51 respectively 61 can in each case be optionally connected in series with the reference potential switches 53 respectively 63, provided that the reference potential switches 53 or, respectively, 63 do not have a reverse blocking capability. Commutation chokes 52 or, respectively, 62 can likewise be connected in series with the reference potential switches 53 or, respectively, 63.

The collecting points of the half-bridge circuits 9 and 15 can each be selectively connected to the reference potential rail 4. This facilitates ensuring a sufficiently high potential difference between the collecting points of the bridge circuits 9 and 15 even when there are low stator voltages between the phase lines 2a, 2b, 2c, for example when there are low rotational speeds or when the electrical machine 2 is at rest, by the neutral point potential of the electrical machine 3 being increased or decreased by a uniform value. This enables the supply of significant electric power from the charging circuit 30 to the energy storage modules 3 of the energy supply branches Z of the energy supply device 1 even at lower motor voltage. In so doing, the neutral point potential of the electrical machine 2 can be displaced with respect to the reference potential by uniformly increasing or decreasing the output voltages at the multiplicity of output connections 1a, 1b, 1c of the energy storage device 1 if the potential difference between the potential which in each case is currently highest and the potential which in each case is currently lowest at the output connections 1a, 1b, 1c of the energy storage device 1 does not reach a predetermined threshold value. That means that the output potentials of all of the energy supply branches Z can be increased or, respectively, decreased by a uniform value without the stator voltages and/or stator currents of the electrical machine being influenced. In order to compensate for fluctuations induced by commutation processes, additional commutation chokes 52 or, respectively, 62 can in each case be connected in series with the respective reference potential diodes 51 or, respectively, 61 and reference potential switches 53 or, respectively, 63. The reference potential switch 63 then forms—if applicable together with the reference potential diode 61 and the commutation choke 62—a second compensation branch 60. In so doing, the reference potential switch 53 allows for the use of a displacement of the neutral point potential of the electrical machine 2 towards positive values for charging the energy storage modules 3 of the energy supply branches Z of the energy supply device 1. To this end, at least one of the second semiconductor switches 15c is closed, i.e. conductively connected. In the process, preferably only that switch of the second semiconductor switches 15c is closed which connects the anode collecting point of the second semiconductor circuit 15 to the phase line 2a, 2b, 2c having the currently highest potential. In a corresponding manner, the reference potential switch 63 allows for the use of a displacement of the neutral point potential of the electrical machine 2 towards negative values in order to charge the energy storage modules 3 of the energy supply branches Z of the energy supply device 1. To this end, at least one of the first semiconductor switches 9c is closed, i.e conductively connected. Preferably only that switch of the first semiconductor switches 9c is closed which connects the cathode collecting point of the first semiconductor circuit 9 to the phase line 2a, 2b, 2c having the potential which is currently the lowest. There is also the option of configuring the DC voltage tap arrangement 8 so as to have only one of the two reference potential switches 53 or 63. In this case, a displacement of the neutral point potential of the electrical machine 2 with respect to the reference potential can be used only in a direction for charging the energy storage modules 3 of the energy supply branches Z of the energy supply device 1.

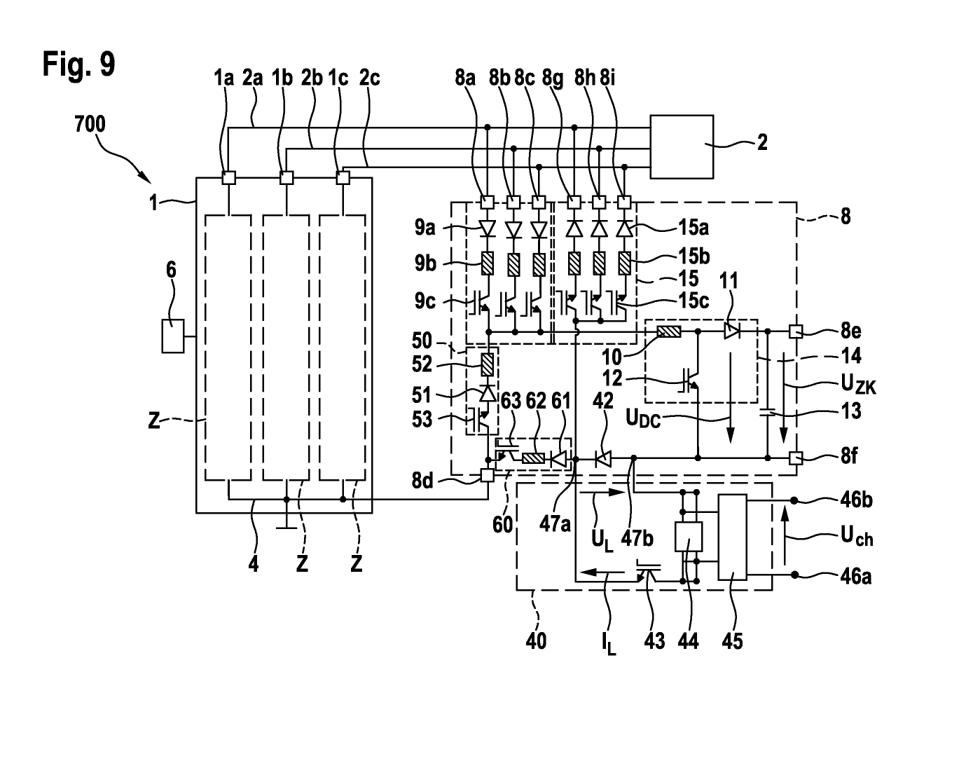

A further system 700 comprising an energy storage device 1 and a DC voltage tap arrangement 8 is shown in FIG. 9. The system 700 of FIG. 9 differs from the system 600 in FIG. 8 by virtue of the fact that the charging circuit 40 described in connection with FIGS. 6 and 7 is used instead of the charging circuit 30 described in connection with FIGS. 4 and 5.

All of the switching elements of the specified circuit arrangements can comprise power semiconductor switches, for example normally blocking or normally conducting n- or p-channel IGBT switches or corresponding MOSFET switches. When using power semiconductor switches having reverse blocking capability, the corresponding series circuits comprising diodes can be omitted.

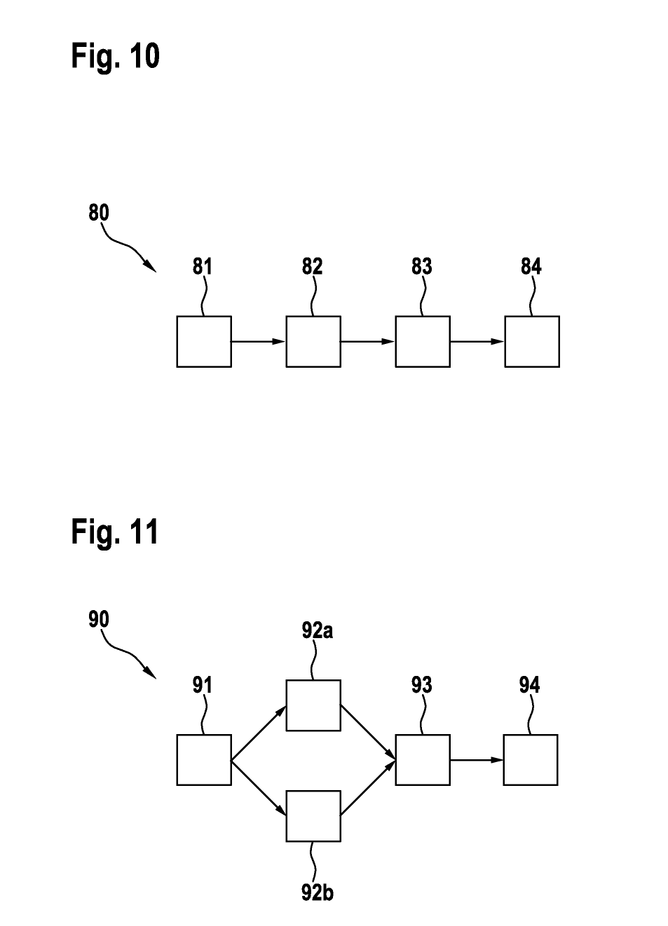

FIG. 10 shows a schematic depiction of a method 80 for charging an energy storage device, in particular an energy storage device 1 as described in connection with FIGS. 1 to 3. The method 80 can, for example, be used for charging an energy storage device 1 of an electrically operated vehicle comprising an electric drive system 200, 300, 400 or 500 of FIGS. 4 to 7.

In a first step 81, a charging direct current I_{L} can initially at least occasionally be generated in a charging circuit as a function of a charging DC voltage U_{L}. Parallel thereto in a second step 82, in electric drive systems 200 and 400 of FIGS. 4 and 6, a supply node 37a, 37b, 47a or, respectively 47b of the charging circuit can be selectively coupled to one or a plurality of the multiplicity of output connections 1a, 1b, 1c of the energy storage device 1; thus enabling only such output connections 1a, 1b, 1c which have a lower output potential than the reference potential rail 4 of the energy storage device 1 to be coupled via the half-bridge circuit 9 to the charging circuit. Parallel thereto in a second step 82, in electric drive systems 300 and 500 of FIGS. 5 and 7, a supply node 37a, 37b, 47a or, respectively 47b of the charging circuit can be selectively coupled to one or a plurality of the multiplicity of output connections 1a, 1b, 1c of the energy storage device 1; thus enabling only such output connections 1a, 1b, 1c which have a higher output potential than the reference potential rail 4 of the energy storage device 1 to be coupled via the half-bridge circuit 9 to the charging circuit. In step 83, the charging direct current I_{L} can then be fed into a portion of the energy supply modules 3 via the output connections 1a, 1b, 1c of the energy storage device 1 coupled to the charging circuit so that, in step 84, the direct current I_{L} can be fed via the reference potential rail 4 of the energy storage device 1 back into the charging circuit.

FIG. 11 shows a schematic depiction of a further method 90 for charging an energy storage device, in particular an energy storage device 1 as described in connection with FIGS. 1 to 3. The method 90 can, for example, be used for charging an energy storage device 1 of an electrically operated vehicle comprising an electric drive system 600 or 700 of FIGS. 8 to 9.

In a first step 91, a charging direct current I_{L} can at least occasionally be generated in a charging circuit as a function of a charging DC voltage U_{L}. In steps 92a and 92b, a first supply node of the charging circuit can in each case be selectively coupled via a first half-bridge circuit 9 to one or a plurality of the multiplicity of output connections 1a, 1b, 1c of the energy storage device 1 which have a lower output potential than the reference potential rail 4 of the energy storage device 1. A second supply node of the charging circuit can also be selectively coupled via a second half-bridge circuit 15 to one or a plurality of the multiplicity of output connections 1a, 1b, 1c of the energy storage device 1 which have a higher output potential than a reference potential rail 4 of the energy storage device 1. Alternatively in step 92a, a selective coupling of the first supply node of the charging circuit to the reference potential rail 4 of the energy supply device via a compensation branch 50 can be carried out. This usually takes place if the potentials of the output connections 1a, 1b, 1c of the energy storage device 1 all have a positive potential with respect to the reference potential rail 4. Additionally in step 92b, a selective coupling of the second supply node of the charging circuit to the reference potential rail 4 of the energy supply device via a compensation branch 60 can be carried out. This usually takes place if the potentials of the output connections 1a, 1b, 1c of the energy storage device 1 all have a negative potential with respect to the reference potential rail 4.

In step 93, the charging direct current I_{L} can subsequently be fed via the output connections 1a, 1b, 1c, which are coupled to the charging circuit by means of the second half-bridge circuit 15 or the compensation branch 60, or the reference potential rail 4 into a portion of the energy storage modules 3 of the energy storage device 1, which, in step 94, can be fed back via the first half-bridge circuit 9 or the compensation branch Z into the charging circuit.

1. A charging circuit for an energy storage device (1), which has a multiplicity of energy supply branches (Z) each with a multiplicity of energy storage modules (3) for generating an AC voltage at a multiplicity of output connections (la, 1b, 1c) of the energy storage device (1), comprising:
a first half-bridge circuit (9) having a multiplicity of first supply connections (8a, 8b, 8c) each coupled to one of the output connections (1a, 1b, 1c) of the energy storage device (1);
a first supply node (37a; 37b; 47a; 47b) coupled to the first half-bridge circuit (9);
a second supply node (37a; 37b; 47a; 47b) coupled to a reference potential rail (4) of the energy storage device (1);
a converter inductor (10) connected between the first supply node (37a, 37b; 47a; 47b) and the first half-bridge circuit (9);
a diode half-bridge (32) coupled between the first supply node (37a; 37b; 47a) and the second supply node (37a; 37b, 47b); and
a supply circuit (35; 44, 45) configured to at least occasionally provide a charging DC voltage (U_{L}) between the first supply node (37a; 37b; 47a; 47b) and the second supply node (37a; 37b; 47a; 47b),
wherein the first half-bridge circuit (9) has a multiplicity of semiconductor switches (9c) each coupled between the first supply node (37a; 37b; 47a; 47b) and one of the multiplicity of first supply connections (8a, 8b, 8c).

2. The charging circuit according to claim 1, wherein the first half-bridge circuit (9) furthermore has a multiplicity of diodes (9a) each coupled between the first supply node (37a; 37b; 47a; 47b) and one of the multiplicity of first supply connections (8a, 8b, 8c).

3. The charging circuit according to claim 1, wherein the first half-bridge circuit (9) further comprising a multiplicity of commutation chokes (9b) each coupled between the multiplicity of diodes (9a) or semiconductor switches (9c) and the first supply node (37a; 37b; 47a; 47b).

4. The charging circuit according to claim 1, further comprising:
a second half-bridge circuit (15) having a multiplicity of second supply connections (8g, 8h, 8i) each coupled to one of the output connections (1a, 1b, 1c) of the energy storage device (1), wherein the second half-bridge circuit (15) is connected to the second supply node (37a; 37b;
47a; 47b) and wherein the second half-bridge circuit (15) has a multiplicity of semiconductor switches (15c) each coupled between the second supply node (37a; 37b; 47a; 47b) and one of the multiplicity of second supply connections (8g, 8h, 8i).

5. The charging circuit according to claim 4, wherein the second half-bridge circuit (15) further further comprising a multiplicity of diodes (15a) each coupled between the second supply node (37a; 37b; 47a; 47b) and one of the multiplicity of second supply connections (8g, 8h, 8i).

6. The charging circuit according to claim 5, wherein the second half-bridge circuit (15) further comprising a multiplicity of commutation chokes (15b), each coupled between the multiplicity of diodes (15a) or semiconductor switches (15c) and the second supply node (37a; 37b; 47a; 47b).

7. The charging circuit according to claim 4, further comprising:
a first reference potential switch (53) which is coupled between the first supply node (37a; 37b; 47a; 47b) and the reference potential rail (4) of the energy storage device (1); and/or a second reference potential switch (63) coupled between the second supply node (37a; 37b; 47a; 47b) and the reference potential rail (4) of the energy storage device (1).

8. The charging circuit (30; 40) according to claim 7, wherein a first reference potential diode (51) is connected in series with the first reference potential switch (53), and/or wherein a second reference potential diode (61) is connected in series with the second reference potential switch (63).

9. The charging circuit (30; 40) according to claim 7, wherein a first commutation choke (52) is connected in series with the first reference potential switch (53), and/or wherein a second commutation choke (62) is connected in series with the second reference potential switch (63).

10. The charging circuit according to claim 1, wherein the supply circuit has a supply capacitor (35) which is coupled between two input connections (36a; 36b) of the charging circuit and which is configured to provide the input DC voltage (U_{N}) for the charging circuit.

11. The charging circuit according to claim 1, wherein the supply circuit has a transformer (45), the primary winding of which is coupled between two input connections (46a; 46b) of the charging circuit, and a full bridge rectifier (44), which is coupled to the secondary winding of the transformer (45) and which is configured to provide a pulsating charging DC voltage for charging the energy storage modules (3).

12. An electric drive system (200; 300; 400; 500; 600; 700), comprising:
an energy storage device (1) having a plurality of energy supply branches (Z) each with a multiplicity of energy storage modules (3) for generating an AC voltage at a multiplicity of output connections (1a, 1b, 1c) of the energy storage device (1);
a charging circuit according to claim 1, the first supply connections (8a, 8b, 8c) of which are each coupled to one of the output connections (1a, 1b, 1c) of the energy storage device (1) and the second supply node (37a; 37b; 47a; 47b) of which is coupled to a reference potential rail (4) of the energy storage device (1).

13. The electric drive system (200; 300; 400; 500; 600; 700) according to claim 12 further comprising:
an n-phase electrical machine (2) having n phase connections, said electrical machine being coupled to the output connections (1a, 1b, 1c) of the energy storage device (1), wherein n≧1.

14. A method (80) for charging an energy storage device (1) during a voltage generating operation of the energy storage device (1), wherein the energy storage device (1) has a multiplicity of energy supply branches (Z) each having a plurality of energy storage modules (3) for generating an AC voltage at a multiplicity of output connections (1a, 1b, 1c) of the energy storage device (1), comprising the following steps:
generating (81) at least occasionally a direct current (I_{L}) in a charging circuit as a function of a charging DC voltage (U_{L});
selectively coupling (82) a supply node (37a; 37b; 47a; 4b) of the charging circuit to one or a plurality of the multiplicity of output connections (1a, 1b, 1c) of the energy storage device (1), which have an output potential with a uniform sign vis-à-vis a reference potential rail (4) of the energy storage device (1), via a half-bridge circuit (9);
feeding (83) the direct current (I_{L}) into a portion of the energy supply modules (3) via the output connections (1a, 1b, 1c) of the energy storage device (1); and
feeding (84) the direct current (I_{L}) back via the reference potential rail (4) of the energy storage device (1).

15. A method (90) for charging an energy storage device (1) during a voltage generating operation of the energy storage device (1), wherein the energy storage device (1) has a plurality of energy storage branches (Z) each having a plurality of energy storage modules (3) for generating an AC voltage at a plurality of output connections (1a, 1b, 1c) of the energy storage device (1), the method comprising:
generating (91) at least occasionally a direct current (I_{L}) in a charging circuit as a function of a charging DC voltage (U_{L});
selectively coupling (92a) a first supply node (37a; 37b; 47a; 47b) of the charging circuit to one or a plurality of the multiplicity of output connections (1a, 1b, 1c) of the energy storage device (1), which have a lower output potential than a reference potential rail (4) of the energy storage device (1), via a first half-bridge circuit (9) or to the reference potential rail (4) via a first compensation branch (50);
selectively coupling (92b) a second supply node (37a; 37b; 47a; 47b) of the charging circuit to one or a plurality of the multiplicity of output connections (1a, 1b, 1c) of the energy storage device (1), which have a higher output potential than a reference potential rail (4) of the energy storage device (1), via a second half-bridge circuit (9) or to the reference potential rail (4) via a second compensation branch (60);
feeding (93) the direct current (I_{L}) into a portion of the energy storage modules (3) via the output connections (1a, 1b, 1c) of the energy storage device (1), which are coupled to the charging circuit, and the first half-bridge circuit (9) or via the reference potential rail (4) and the first compensation branch (50); and
feeding (94) the direct current (I_{L}) back via the second half-bridge circuit (15) or the second compensation branch (60) into the charging circuit.

16. The method (80) according to claim 14, wherein the method (80) is for charging an energy storage device (1) of an electrically operated vehicle comprising an electric drive system (200; 300; 400; 500; 600; 700).

17. The method (90) according to claim 15, wherein the method (90) is for charging an energy storage device (1) of an electrically operated vehicle comprising an electric drive system (200; 300; 400; 500; 600; 700).
